(19) United States
(12) Patent Application Publication
(10) Pub. No.: US 2025/0305465 A1
(43) Pub. Date: Oct. 2, 2025

(54) VEHICLE

(71) Applicant: HONDA MOTOR CO., LTD., Tokyo (JP)

(72) Inventors: Shumpei HATTORI, Tokyo (JP); Teppei MAEDA, Tokyo (JP); Ryota SAKAMOTO, Tokyo (JP)

(21) Appl. No.: 19/091,835

(22) Filed: Mar. 27, 2025

(30) Foreign Application Priority Data
Mar. 29, 2024 (JP) 2024-058015

(51) Int. Cl. F02D 41/22; F02D 41/00; F02D 41/04

(52) U.S. Cl. CPC F02D 41/22; F02D 41/0002; F02D 41/042; F02D 2200/101

(57) ABSTRACT

Provided is a vehicle that can improve restartability by causing a crankshaft to stop at a desired position upon stopping an internal combustion engine. In a vehicle (50) that drives a throttle valve (13) adjusting the output of an internal combustion engine (E) by an actuator (14), and has an ignition switch (40) that turns on and off an electrical power supply, the vehicle further includes a throttle valve controller (32) that controls driving of the throttle valve (13); and a power consumption detector (31) that detects electrical power usage of the vehicle (50). The throttle valve controller (32) performs throttle valve full-close control for fully closing the throttle valve (13), when the electrical power usage detected by the power consumption detector (31) is a predetermined value or less, upon the ignition switch (40) being turned off.

This application is based on and claims the benefit of priority from Japanese Patent Application No. 2024-058015, filed on 29 Mar. 2024, the content of which is incorporated herein by reference.

### BACKGROUND OF THE INVENTION

### Field of the Invention

The present invention relates to a vehicle, and particularly relates to a vehicle which can improve startability upon restarting an internal combustion engine as a drive source after being stopped.

### Related Art

In the prior art, a design for improving the startability upon restarting an internal combustion engine as a drive source of a vehicle after being stopped has been considered.

Japanese Unexamined Patent Application, Publication No. 2004-245105 discloses technology that improves the restartability by which assuming a stop position of the crankshaft when stopping an internal combustion engine, and during restart, performing fuel injection and ignition control adapted to this assumed stop position.

Patent Document 1: Japanese Unexamined Patent Application, Publication No. 2004-245105

### SUMMARY OF THE INVENTION

However, the technology of Japanese Unexamined Patent Application, Publication No. 2004-245105 assumes the stop position of the crankshaft upon stopping the internal combustion engine, and does not give consideration to actively stopping the crankshaft at a desired position which enhances the restartability, upon stopping the internal combustion engine.

An object of the present invention is to solve the problem of the above-mentioned conventional technology, and to provide a vehicle which can improve restartability by stopping the crankshaft at a desired position upon stopping an internal combustion engine.

In order to achieve the above-mentioned object, a first aspect of the present invention provides a vehicle (50) that drives a throttle valve (13) adjusting output of an internal combustion engine (E) by an actuator (14), and maintains an idling state when the actuator (14) is not being driven, by using a mechanism that maintains the throttle valve (13) to a small opening state, the vehicle (50) comprising:

an ignition switch (40) that turns on and off an electrical power source; a throttle valve controller (32) that controls driving of the throttle valve (13); and a power consumption detector (31) that detects electrical power usage of the vehicle (50), in which the throttle valve controller (32) performs throttle valve full-close control for fully closing the throttle valve (13), when the electrical power usage detected by the power consumption detector (31) is a predetermined value or less, upon the ignition switch (40) being turned off.

In addition, according to a second aspect of the present invention, the throttle valve full-close control is performed upon a revolution speed of the internal combustion engine (E) being no more than a predetermined value which is lower than the idling revolution speed.

Moreover, according to a third aspect of the present invention, the throttle valve controller (32) performs spring check as a fault diagnosis that repeats full open and full close of the throttle valve (13), after stopping of the internal combustion engine (E).

Furthermore, according to a fourth aspect of the present invention, the throttle valve controller (32), after ending of the spring check, sets the throttle valve (13) to a small opening state by turning off control of the actuator (14).

According to the first aspect, in the vehicle (50) having the ignition switch (40) that turns on and off an electrical power supply, the throttle valve (13) adjusting the output of the internal combustion engine (E) is driven by the actuator (14), and an idling state is maintained using a mechanism that maintains a small opening state of the throttle valve (13) when this actuator (14) is not being driven. The vehicle further includes the throttle valve controller 32 for controlling driving of the throttle valve 13 and the power consumption detector 31 for detecting the electrical power usage of the vehicle 50. The throttle valve controller 32 performs throttle valve full-close control to fully close the throttle valve 13 in the case of the electrical power usage detected by the power consumption detector 31 being no more than a predetermined value upon the ignition switch 40 being turned OFF. Therefore, if turning OFF the ignition switch during usage of a large electrical load such as the air conditioner or heater, the load of the internal combustion engine decreases and the revolution speed rises by the power generation load vanishing, and the crankshaft will stop at a position favorable for restartability; however, if turning OFF the ignition switch in a state with little electrical load, there is a possibility of the revolution speed of the internal combustion engine dropping in this state, and the crankshaft stopping at a position with reduced restartability. In contrast, in the case of turning OFF the ignition switch when the electrical load is small, it becomes possible to generate pumping loss by fully closing the throttle valve, to cause the crankshaft to stop at a position favorable for restart.

According to the second aspect, the throttle valve full-close control is performed upon the revolution speed of the internal combustion engine (E) being no more than a predetermined value which is lower than the idling revolution speed. Therefore, it becomes possible to perform stable valve closing control in a situation where there is little rotation fluctuation due to external factors, and cause the crankshaft to stop at the desired position.

According to the third aspect, the throttle valve controller (32) performs spring check as a fault diagnosis that repeats full open and full close of the throttle valve (13), after stopping of the internal combustion engine (E). Therefore, in the case of there being some kind of defect in the drive mechanism of the throttle valve, by performing the spring check after stopping of the internal combustion engine, it becomes possible to inform a passenger by a display device or the like upon turning ON the ignition switch next.

According to the fourth aspect, the throttle valve controller (32), after ending of the spring check, sets the throttle valve (13) to a small opening state by turning off control of the actuator (14). Therefore, by the throttle valve returning to the small opening state after ending of spring check, and making preparations for restart, the smooth restart of the internal combustion engine is possible.

### BRIEF DESCRIPTION OF THE DRAWINGS

FIG. 1 is an explanatory drawing showing a control device of a vehicle and peripheral configurations thereof;

FIG. 2 is a timing chart showing the combustion cycle and valve timing of an engine; and

FIG. 3 is a flowchart showing a sequence of restartability improving control according to the present embodiment.

### DETAILED DESCRIPTION OF THE INVENTION

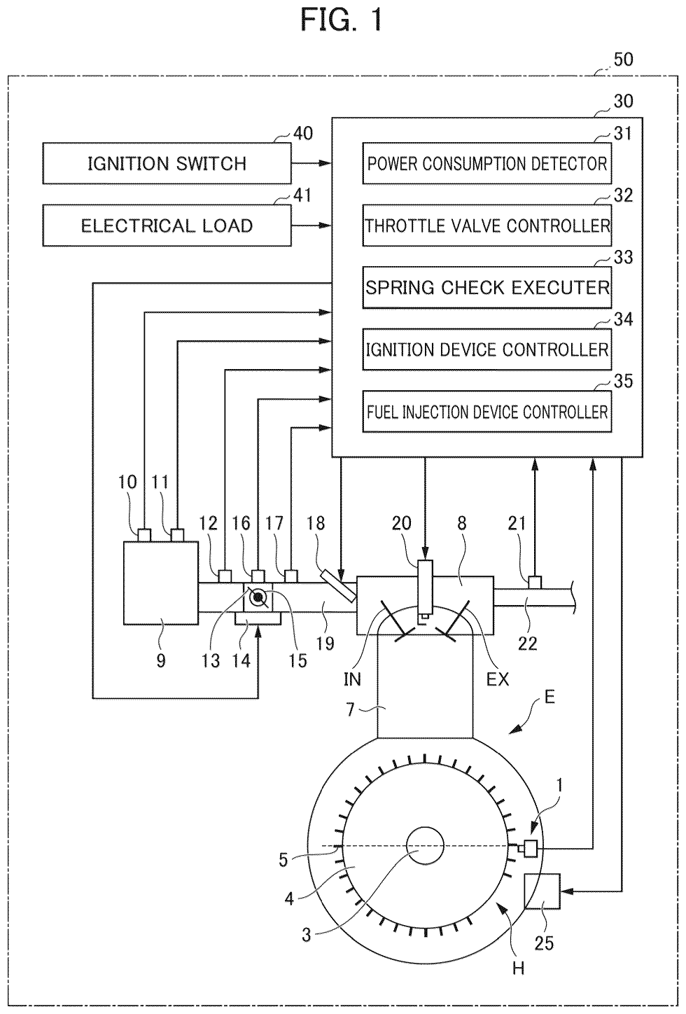

Hereinafter, a preferred mode for carrying out the present invention will be described in detail by referencing the drawings. FIG. 1 is an explanatory drawing showing a control device 30 of a vehicle 50 according to an embodiment of the present invention and peripheral configurations thereof. A cylinder head 8 in which intake valves IN and exhaust valves EX are accommodated is mounted to the top of cylinders 7 of an engine E, which is 4-cycle inline 2-cylinder internal combustion engine. A crank pulser rotor 4 which synchronously rotates with a crankshaft 3 is mounted to the crankshaft 3. A reluctor 5 with a total of 34 teeth arranged at 10 degree intervals except for a tooth-less portion H at one location is provided to the crank pulser rotor 4. A magnetic pickup-type pulse generator 1 outputs a pulse signal to the control device 30 every time detecting the passage of the reluctor 5.

An air cleaner box 9 which filters the intake air is mounted at an end portion of an intake pipe 19. An intake air temperature sensor 10 and atmospheric pressure sensor 11 are provided at the air cleaner box 9. An air flow sensor 12 that meters the intake air amount, a butterfly-type throttle valve 13 driven by an actuator 14, a throttle valve opening sensor 16 that detects the rotation angle of the throttle valve 13, and a PB (intake air pressure) sensor 17 that detects the intake air pressure are mounted to the intake pipe 19. An ignition device 20 is provided to an upper part of a combustion chamber, and a fuel injector 18 is arranged in the intake pipe 19 on the downstream side of the throttle valve 13. An oxygen concentration sensor 21 is mounted to an exhaust pipe 22. In the present embodiment, it is configured to drive the throttle valve 13 adjusting the output of the engine E with the actuator 14, and to perform running at an idling revolution speed by a small opening of the throttle valve 13. The present embodiment has a mechanism maintain a small opening state of the throttle valve 13 when the actuator 14 is not being driven.

Output signals from an ignition switch 40 and an electrical load 41 are inputted to the control device 30. After operating the ignition switch 40 to turn ON the electrical power source of the vehicle, if operating a start switch (not shown), the cranking of the crankshaft 3 by a starter motor 25 is started. On the other hand, when the electrical power supply of the vehicle 1 is turned OFF by turning OFF the ignition switch 40 during running of the engine E, the engine E stops.

The control device 30 includes a power consumption detector 31 for detecting the electrical power usage of a vehicle 50 by the electrical load 41 such as an air conditioner or a heater, a throttle valve controller 32, a spring check executer 33 for performing fault diagnosis of a throttle valve drive mechanism after stopping of the engine E, an ignition device controller 34 for controlling the ignition device 20 at a predetermined ignition timing, and a fuel injection device controller 35 for controlling the fuel injectors 18 at a predetermined injection timing.

Upon turning OFF the ignition switch 40 in order to stop the engine E, while normally the engine E stops after inertia rotation while keeping the throttle valve 13 at a small aperture, if the electrical power usage of the vehicle 50 is no more than a predetermined threshold, the control device 30 according to the present embodiment is configured so as to generate a pumping loss by fully closing the throttle valve 13 to cause the crankshaft 3 to stop at a position favorable for restart.

When turning OFF the ignition switch 40 while using a large electrical load 41 such as the air conditioner or heater, the revolution speed of the engine E slightly rises by the power generation load vanishing, and the crankshaft 3 will stop at a position favorable for restartability. However, when turning OFF the ignition switch 40 in a state with little power generation load, the revolution speed of the engine E drops in this state, and the crankshaft 3 may stop at a position with reduced restartability. The above configuration is made to address this situation.

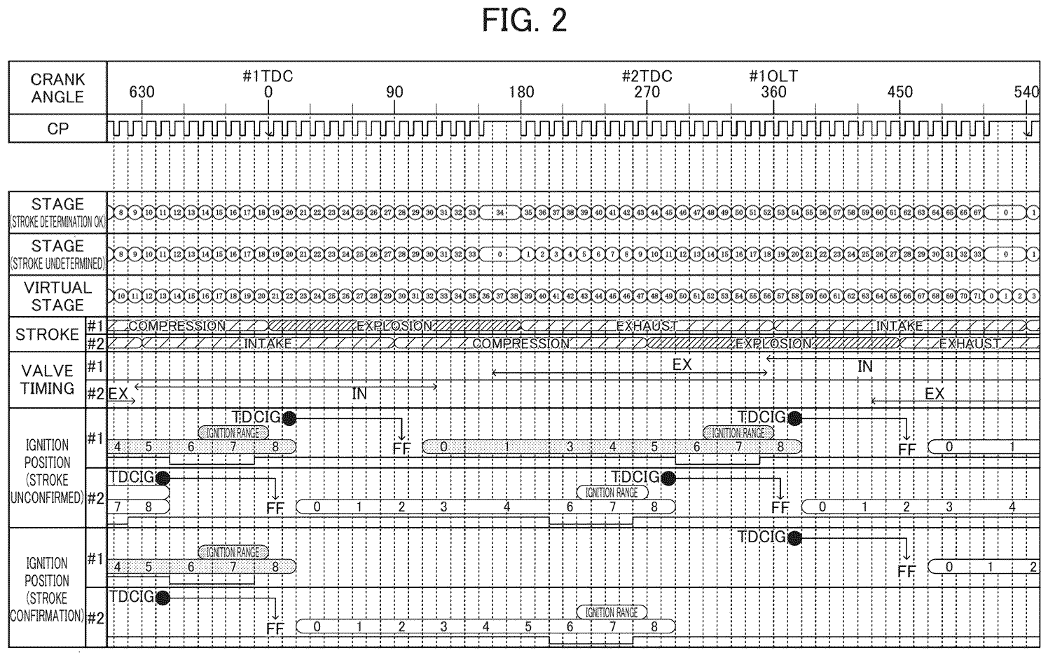

FIG. 2 is a timing chart showing the relationship between the combustion cycle and valve timing of the engine E. The combustion cycle of the engine E consists of the four strokes of compression, explosion, exhaust and intake. Each of the strokes is determined based on the crank pulse outputted from the pulse generator 1. More specifically, when the tooth-less portion H of the reluctor 5 is detected according to the crank pulses, the position at which a predetermined number of crank pulses were detected since then is determined as a reference position of the crank pulser rotor 4, and one rotation of the crankshaft 3 is divided into the 34 crank stages according to the arrangement of the reluctor 5. Subsequently, based on the fluctuation state of the intake air pressure detected by the PB sensor 17, a front-back determination as to whether the crankshaft 3 is on either the first rotation or the second rotation in one cycle (720 degrees) is performed, and stroke determination completes by one cycle being divided into 68 stages.

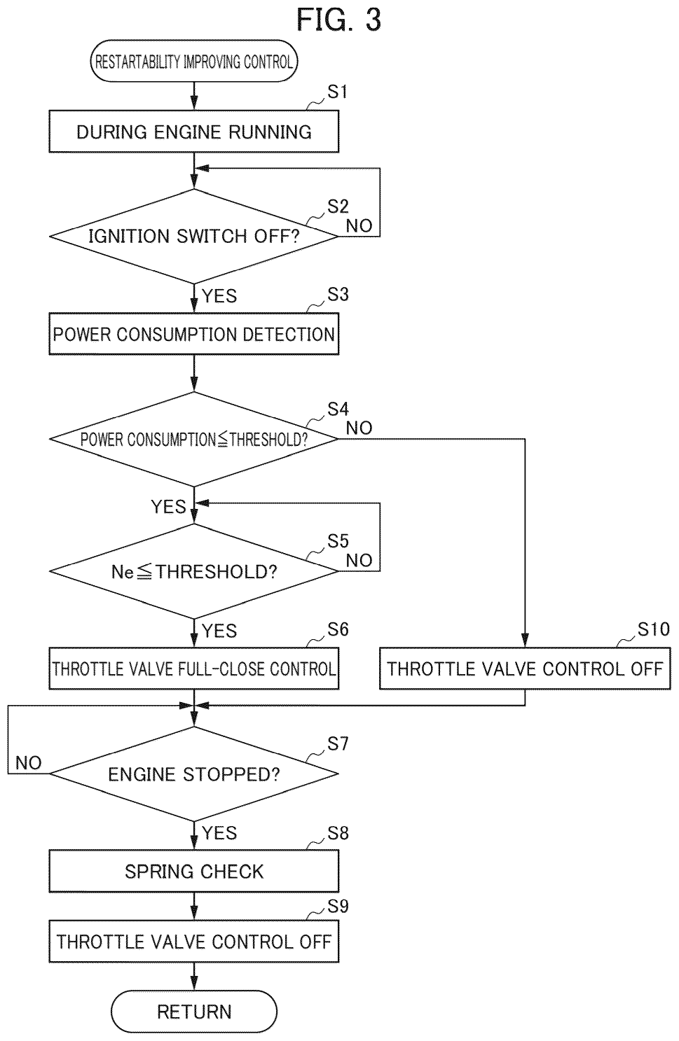

FIG. 3 is a flowchart showing a sequence of restartability improving control according to the present embodiment. In Step S1, the engine E is in a running state. In Step S2, it is determined whether the ignition switch 40 is turned OFF, and when the determined in the affirmative, the processing advances to Step S3. When determined in the negative in Step S2, the processing is returned to the determination of Step S2.

In Step S3, the electrical power usage of the vehicle 50 is determined by the power consumption detector 31. Next, in Step S4, it is determined whether the electrical power consumption is no more than a predetermined threshold, and when determined in the affirmative, the processing advances to Step S5. In Step S5, it is determined whether the engine revolution speed Ne is no more than a predetermined threshold (e.g., 800 rpm), which is lower than the idling revolution speed, and when determined in the affirmative, the processing advances to Step S6.

In Step S6, throttle valve full-close control for fully closing the throttle valve 13 is performed by the throttle valve controller 32. It is thereby possible to generate pumping loss in the engine E to cause the crankshaft 3 to stop at a desired angle favorable for restartability. Next, in Step S7, it is determined whether the engine E has stopped, and when determined in the affirmative, the processing advances to Step S8.

In Step S8, the spring check as a failure diagnosis which repeats full open and full close of the throttle valve 13 is performed. In the case of there being some kind of defect in the drive mechanism of the throttle valve 13, it becomes possible to inform a passenger by a display device or the like upon turning ON the ignition switch 40 next.

Then, in Step S9, throttle valve controlled OFF for setting the throttle valve 13 to a small opening is performed by turning OFF the driving of the actuator 14, and then the series of controls is ended. According to this throttle valve control OFF, the smooth restart of the engine E becomes possible by setting the throttle valve 13 to a small opening after the end of the spring check, and making preparations for restart. On the other hand, in the case of being determined in the negative in Step S4, i.e. in the case of the electrical power usage of the vehicle 50 exceeding a predetermined threshold upon turning OFF the ignition switch 40, the throttle valve full-close control is made unnecessary, and the processing advances to Step S10. In Step S10, the throttle valve control OFF is performed, and the processing advances to Step S7.

As described above, according to the control device 30 related to the present invention, in the vehicle 50 having the ignition switch 40 that turns on and off an electrical power supply, the throttle valve 13 adjusting the output of the engine E is driven by the actuator 14, and an idling state is maintained using a mechanism that maintains a small opening state of the throttle valve 13 when this actuator 14 is not being driven. The vehicle further includes a the throttle valve controller 32 for controlling driving of the throttle valve 13 and the power consumption detector 31 for detecting the electrical power usage of the vehicle 50. The throttle valve controller 32 performs throttle valve full-close control to fully close the throttle valve 13 in the case of the electrical power usage detected by the power consumption detector 31 being no more than a predetermined threshold upon the ignition switch 40 being turned OFF. Therefore, if turning OFF the ignition switch 40 during usage of a large electrical load 41 such as the air conditioner or heater, the revolution speed of the engine E slightly rises by the power generation load vanishing, and the crankshaft 3 will stop at a position favorable for restartability; however, if turning OFF the ignition switch 40 in a state with little power generation load, there is a possibility of the revolution speed of the engine E dropping in this state, and the crankshaft 3 stopping at a position with reduced restartability. In contrast, in the case of turning OFF the ignition switch 40 when the electrical load is small, it becomes possible to generate pumping loss by fully closing the throttle valve 13, to cause the crankshaft 3 to stop at a position favorable for restart.

The form of the vehicle, type of electrical load, preferred angle for stopping the crankshaft upon stopping the engine, angular range of crankshaft with reduced restartability, threshold for electrical power usage as an execution condition for the throttle valve full-close control, threshold for engine revolution speed as an execution condition for spring check, etc. are not limited to the above-mentioned embodiment, and various modifications thereto are possible. In addition to motorcycles, the control device according to the present invention can be applied to various vehicles such as three-wheeled and four-wheeled vehicles establishing a power unit including an internal combustion engine as the drive source.

### EXPLANATION OF REFERENCE NUMERALS

50 vehicle
E engine (internal combustion engine)
13 throttle valve
14 actuator
30 control device
31 power consumption detector
32 throttle valve controller
40 ignition switch

What is claimed is:

1. A vehicle (50) that drives a throttle valve (13) adjusting output of an internal combustion engine (E) by an actuator (14), and maintains an idling state when the actuator (14) is not being driven, by using a mechanism that maintains the throttle valve (13) to a small opening state, the vehicle (50) comprising:
an ignition switch (40) that turns on and off an electrical power source;
a throttle valve controller (32) that controls driving of the throttle valve (13); and
a power consumption detector (31) that detects electrical power usage of the vehicle (50),
wherein the throttle valve controller (32) performs throttle valve full-close control for fully closing the throttle valve (13), when the electrical power usage detected by the power consumption detector (31) is a predetermined value or less, upon the ignition switch (40) being turned off.

2. The vehicle according to claim 1, wherein the throttle valve full-close control is performed upon a revolution speed of the internal combustion engine (E) being no more than a predetermined value which is lower than the idling revolution speed.

3. The vehicle according to claim 1, wherein the throttle valve controller (32) performs spring check as a fault diagnosis that repeats full open and full close of the throttle valve (13), after stopping of the internal combustion engine (E).

4. The vehicle according to claim 3, wherein the throttle valve controller (32), after ending of the spring check, sets the throttle valve (13) to a small opening state by turning off control of the actuator (14).
